(19) United States
(12) Patent Application Publication
(10) Pub. No.: US 2015/0012194 A1
(43) Pub. Date: Jan. 8, 2015

(54) METHOD FOR OPERATING A MANUAL TRANSMISSION IN A MOTOR VEHICLE

(71) Applicant: Audi AG, Ingolstadt (DE)

(72) Inventor: Mathias Braun, Munchen (DE)

(73) Assignee: AUDI AG, Ingolstadt (DE)

(21) Appl. No.: 14/365,917

(22) PCT Filed: Nov. 23, 2012
(86) PCT No.: PCT/EP2012/004843

§ 371 Date: Jun. 16, 2014

(30) Foreign Application Priority Data
Dec. 17, 2011 (DE) 10 2011 121 476.7

(51) Int. Cl. F16H 61/68; F16H 59/04

(52) U.S. Cl. CPC F16H 61/68; F16H 59/04
USPC 701/64

(57) ABSTRACT

A method for operating a manual transmission in a motor vehicle, includes recognizing in driving states of the motor vehicle in which no gear is engaged in the manual transmission a condition indicating that a gear is to be engaged; and displaying which gear is to be engaged in the manual transmission.

The invention relates to a method for operating a manual transmission in a motor vehicle.

From U.S. Pat. No. 5,017,916 A a switch display for a motor vehicle is known which is operated in a driving mode, a prompt mode and a switching mode. In the switching mode, in which the display is for example switched when actuating the clutch, the display displays to the driver the gear to be engaged.

WO 2008/081 220 A1 describes a gear display device for a motor vehicle, which displays to a driver the number and the direction of the gear changes to be performed.

From DE 10 2010 020 495 A1 it is known to engage a gear in a transmission when driving downhill to reduce wear on the brakes of a motor vehicle.

From DD 214 812 A1 a control circuit for a gear shift indicator in a motor vehicle is known in which a recommendation for shifting to a higher or lower gear is issued depending on a speed of the motor and a sound level.

A similar state of the art is described in DD 217 337 A1 in which recommendations are displayed to the driver by way of a display, according to which recommendations the driver can switch to a lower or higher gear. When actuating the motor brake, driving in the reverse gear and in the shift lever position neutral, the display is turned off.

A further gear shift indicator for motor vehicles is known from. DE 850 395 C in which also recommendations for switching to a higher or lower gear are issued when the gear is selected and the transmission is engaged. In this way the fuel consumption is intended to be lowered in that the combustion engine is operated in a defined speed range.

DE 32 37 517 A1 also describes a gearshift indicator for a gear transmission in which the display appears on a field, which lies in the direction in which the shift lever has to be moved for engaging a defined gear.

In the gearshift indicators described in the above mentioned publications, which can partially be used in similar form in current motor vehicles, the gear display is extinguished when engaging the neutral position during standstill and also during driving operation. When the driver thus engages the neutral gear he has to select the fitting gear stage prior to a desired acceleration so that the rotational speed of the combustion engine is adjusted to an appropriate range depending of he driving speed without the motor being killed due to an excessively high gear stage or the rotational speed unnecessarily increases due to a too low gear stage.

It is an object of the present invention to create a method for operating a manual transmission in a motor vehicle which makes it easier for the driver of the motor vehicle to select a fitting gear during the drive when terminating the neutral phase.

According to the invention this object is solved by the features set forth in patent claim 1.

The method according to the invention in which in driving states in which no gear is engaged in the manual transmission and it is recognized that a gear is to be engaged, it is displayed which gear to engage, makes it easier for the driver of the motor vehicle to select the appropriate gear stage when he desires to engage a gear after a phase in which no gear was engaged. Displaying the appropriate gear prevents a killing of the combustion engine or an excessive increase of the rotational speed of the same, when transitioning from a phase in which the motor vehicle was operated in neutral to an acceleration phase.

The desire to accelerate can easily be recognized when in an advantageous refinement of the invention it is recognized that a gear is to be engaged when the clutch, which is connected with the manual transmission, is actuated. Because the driver has to actuate the clutch, which is connected with the manual transmission, when engaging the gear in the manual transmission, the desire to engage a gear in the manual shift can be easily determined in this way.

For the driver it is particularly advantageous I this case when the gear to be engaged in the manual transmission is displayed when actuating the clutch.

A simple possibility for determining the gear to be engaged can be to determined from the speed of the motor vehicle which gear is to be engaged.

When it is provided preferably in addition or as the case may be as an alternative that to determine from the rotational speed of a combustion engine which is expected based on the speed of the motor vehicle, the respectively appropriate gear which is to be engaged in the manual transmission in the rolling vehicle after the neutral or idle phase, can be determined very accurately.

In order to make it possible for the driver of the motor vehicle to influence the selection of the gear to be engaged it can also be provided that a rotational speed range of the combustion engine which is to be reached when engaging the gear can be selected.

When it is further provided that the gear to be engaged is displayed in a display of a combination instrument, the gear that has to be engaged in the manual transmission after the neutral phase can be recognized very easily.

In order to be able to safe fuel in addition to the aforementioned advantages, an advantageous refinement of the method can also be that in driving situations in which no gear is engaged in the manual transmission and the clutch is not activated, the combustion engine is turned off.

It can also be provided that when motor vehicle drives downhill and no gear is engaged, it is displayed that a gear is to be engaged. This allows using the braking moment to reduce the wear of the brakes.

In the following, an exemplary embodiment of the invention is shown schematically by way of the drawing.

It is shown in:

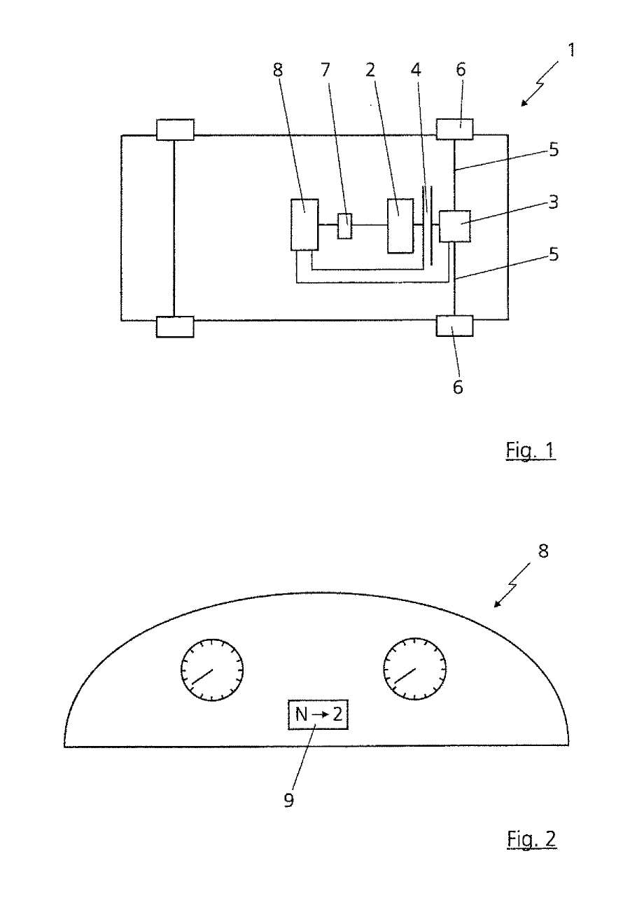

FIG. 1 a very schematic representation of a motor vehicle or carrying out the method according to the invention; and

FIG. 2 a combination instrument of the motor vehicle of FIG. 1.

A motor vehicle 1, schematically shown in FIG. 1, has a combustion engine 2 and a manual transmission 3 connected with the combustion engine 2. The term “manual transmission 3” means a transmission in which a driver of the motor vehicle 1 has to manually engage a gear with a not shown shift lever. The number of gears of the manual transmission 3 is not relevant in this case. The combustion engine 2 is connected with the manual transmission 3 via a clutch 4. Extending from the manual transmission 3 are respective drive shafts 5, with which the wheels 6 of the motor vehicle 1 are driven. in this regard it is not important whether the wheels 6 are the front wheels or the rear wheels of the motor vehicle 1. Because the function of the combustion engine 2, the manual transmission 3 and the clutch 4 and their interaction is known per se, these are not further described here.

Further provided in the motor vehicle 1 is a control device 7 which can be connected with the combustion engine 2, the manual transmission 3 and/or the clutch 4. Further, the control device is connected to a combi-insturment 8 which is situated in the field of vision of a not shown driver which is present in the motor vehicle 1.

As known per se, during normal operation of the motor vehicle, in which the combustion engine 2 drives the wheels 6, a gear is engaged in the manual transmission. In certain driving state it can be useful not to engage a gear in the manual transmission and to operate the the motor vehicle 1 in neutral or coasting mode, for example when driving downhill, when the braking effect of the combustion engine 2 does not have to be used or when rolling out toward a traffic light or another location, at which the motor vehicle 1 has to stop. Of course, there are many other reasons to move the motor vehicle in a driving state in which no gear is engaged in the manual transmission and the later is operated in neutral.

According to the method for operating the manual transmission it is provided in such driving states in which no gear is engaged in the manual transmission 3, that when it is recognized that a gear is being engaged or is to be engaged in the manual transmission 3, it is displayed which gear is to be engaged in the manual transmission 3. The phrase “is to be engaged” represents a recommendation and the driver of the motor vehicle 1 is free to engage a different gear than the one which is displayed to him as recommendation, as will be explained below. Preferably the planed engaging of a gear is recognized in that an actuation of the clutch 4 is recognized. For this a not shown sensor can be used which may be located in the region of the clutch 4. As soon as it is recognized that the clutch was actuated the gear to be engaged in the manual transmission 3 can be displayed.

By selecting the appropriate gear it is ensured that the rotational speed of the combustion engine 2 after releasing the clutch, i.e., when the combustion engine is in force transmitting connection with the manual transmission 3, is within a range in which the combustion engine 2 is neither killed nor the rotational speed of the combustion engine unnecessarily increases. However, an increased rotational speed of the combustion engine 2 may be desired for example when driving downhill in order to build up an increased braking torque. The height of the rotational speed of the combustion engine 2 to be reached of course depends among other things also upon the type of combustion engine for example whether the latter operates on the diesel or the Otto principle.

In order to determine the best fitting gear, which is to be engaged in the manual transmission 3 after the neutral phase, the speed of the motor vehicle 1 and/or the rotational speed of the combustion engine 2 to be expected after engaging the gear can be analyzed. Particularly preferably, the speed of the motor vehicle 1 and the rotational speed of the combustion engine 2 which results from the speed of the motor vehicle 1 are used as parameters for determining the gear to be engaged. Corresponding calculations can be carried out in the control device 7 in which a characteristic field, a calculation model or the like can be stored. In addition, a desired torque recognized via a not shown gas pedal of the motor vehicle 1 can also be taken into account.

Depending on the circumstance, it can also be provided that a driver actively influences the gear to be selected, in that he selects the rotational speed range which is to be reached after the neutral phase when engaging the gear in the manual transmission 3. For example tis possibility of influence can be stored in a corresponding operating system of the motor vehicle 1, for example in a system which is referred to as MMI in the vehicles of the applicant. As the case may be, it can also be provided that this selection of the rotational speed range is performed automatically when selecting an eco-mode, a normal-mode, a sport-mode or other similar modes in the operating system.

FIG. 2 shows the combination instrument 8 of FIG. 1 in enlarged representation and it can be recognized that the combination instrument 8 has a display 9 , in which the gear to be engaged can be displayed. In the present case for this an “N” is displayed in the left hand region of the display for the gear currently engaged in the manual transmission 3 or respectively for the fact that no gear is engaged in the manual transmission. An arrow toward the right hand side indicates the gear to be engaged, in the present case the second gear. For this an already existing display in the combination instrument 8 can be used which for the method according to the invention is advantageously used in parallel to an already existing switching display. Of course other possibilities for displaying the gear go be engaged in the display are conceivable. For example the fact that no gear is engaged can be indicated by an empty field in the display 9.

In addition to the method described above it can be provided that in neutral, i.e., when no gear is engaged in the manual transmission 3 and the clutch 4 is not actuated, the combustion engine 2 is turned off. In this case the combustion engine 2 is started when the clutch 4 is actuated. At the same time, the gear to be engaged is also displayed as described above. The described method can thus be carried out independent of the fact whether the combustion engine 2 is turned on or off.

Depending in the circumstances, in case of driving downhill, when no gear is engaged in the manual transmission 3 and as the case may be when the brakes which act on the wheels 6 are actuated, it can be displayed that a gear is to be engaged in order to utilize the braking torque of the combustion engine 2. In this case it would thus not be strictly required to actuate the clutch 4 to trigger the display that a gear is to be engaged. This mode of operation during downhill drive of the motor vehicle 1 is independent of the fact whether the combustion engine 2 is operated or not. Further, a recommendation as to which gear is to be engaged may also be displayed in this case.

What is claimed is:

1-9. (canceled)

10. A method for operating a manual transmission in a motor vehicle, comprising:
recognizing in driving states of the motor vehicle in which no gear is engaged in the manual transmission that a gear is to be engaged; and
displaying which gear is to be engaged in the manual transmission.

11. The method of claim 1, wherein the recognizing step comprises recognizing an actuation of a clutch connected with the manual transmission as indicating that the gear is to be engaged.

12. The method of claim 11, further comprising displaying the gear to be engaged in the manual transmission when the clutch is actuated.

13. The method of claim 10, further comprising determining which gear is to be engaged as a function of a speed of the motor vehicle,

14. The method of claim 1, further comprising determining which gear is to be engaged as a function of a rotational speed of the combustion engine expected to result when the gear is engaged.

15. The method of claim 14, further comprising selecting a range of the rotational speed of the combustion engine to be achieved when engaging the gear.

16. The method of claim 9, wherein the gear to be engaged is displayed in a display of a combination-instrument.

17. The method of claim 9, further comprising turning off the combustion engine in driving states in which no gear is engaged in the manual transmission and in which the clutch is not actuated.

18. The method of claim 9, further comprising displaying that the gear is to be engaged during a downhill drive of the motor vehicle when the brakes are actuated in driving states in which no gear is engaged in the manual transmission.
